(19) United States
(12) Patent Application Publication
(10) Pub. No.: US 2010/0253627 A1
(43) Pub. Date: Oct. 7, 2010

(54) Motorized Mouse

(76) Inventor: Jack Atzmon, Englewood, NJ (US)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/743,352

(22) PCT Filed: Nov. 17, 2008
(86) PCT No.: PCT/US08/12850

§ 371 Date: May 17, 2010

Related U.S. Application Data
(60) Provisional application No. 60/988,176, filed on Nov. 15, 2007.

(51) Int. Cl. G06F 3/033

(52) U.S. Cl. 345/163

(57) ABSTRACT

A pointing device for a computer and a method of using the pointing device. The pointing device includes a base, a motion tracking device coupled to the base; and a body pivotably coupled to the base. A drive device pivots body with respect to the base about at least one axis.

### CROSS-REFERENCE TO RELATED APPLICATIONS

This is U.S. national stage under 35 USC §371 of Application No. PCT/US2008/012850, filed on Nov. 17, 2008 and claims priority to U.S. Provisional Application No. 60/988,176 filed on Nov. 15, 2007,the contents of which are incorporated herein by reference.

### BACKGROUND OF THE INVENTION

1. Field of the Invention

The present invention relates to computer input devices and specifically to a motorized mouse

2. Description of the Related Art

Using a mouse or other pointing device for extended periods of time is associated with developing a repetitive strain injury (RSI). In place of mice, other devices have been developed such as trackballs or joysticks. Other ergonomic devices such as curved or shaped mice exist. However, these devices do not eliminate the risks of RSI. Additionally, current input devices are generally static devices.

### SUMMARY OF THE INVENTION

A pointing device for a computer and a method of using the pointing device. The pointing device includes a base, a motion tracking device coupled to the base; and a body pivotably coupled to the base. The body pivots with respect to the base about at least one axis. The body is pivoted by a driving mechanism.

### BRIEF DESCRIPTION OF THE DRAWINGS

FIG. 1 depicts a mouse in accordance with one embodiment of the invention;

FIGS. 2A-2C depict a side view of a mouse according to a second embodiment of the invention;

FIGS. 3A-3B depict a front view of the mouse of FIG. 2; and

FIGS. 4A-4D depict a mouse according to another embodiment of the invention.

### DETAILED DESCRIPTION OF THE INVENTION

Disclosed is a pointing device preferably embodied as a robotic mouse configured act as an input device. In one embodiment, the mouse reduces the occurrence of RSI. In a preferred embodiment, the upper surface of the mouse changes its position relative to the lower surface of the mouse or the surface upon which the mouse is used. The motion can be continuous, stepped, periodic, or the like. Further, the mouse is adapted for use by either right or left-handed users. In one embodiment, the mouse's motion is implemented with a motor. In another embodiment, the motion is gear driven in response to motion across a surface. In yet another embodiment, the motion is driven by a self-winding spring or a drive mechanism driven by friction, or the like. In other words, both motorized and non-motorized motion can be used.

It should be noted that the present mouse is preferably a robot as it is an automatically controlled, reprogrammable, multipurpose, manipulator programmable in three or more axes, which may be either fixed in place or mobile for use in industrial automation applications. As such, the present mouse is a robot utilized as an input device.

In one embodiment, there is an indicator, not shown, that indicates when the mouse is moving. The indicator can have a plurality of states to indicate whether the motion is random, stepped, periodic, or the like. Additionally, the indicator can inform the user that the mouse is going to be moving. For example, the indicator can be an LED that blinks before the mouse moving or alternatively, the LED can illuminate before the mouse begins moving. In one embodiment, multi-colored LEDs are used to indicate different states. Alternatively, different illumination patterns can indicate the different states.

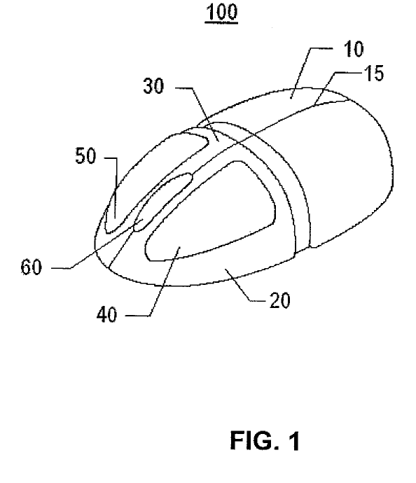

FIG. 1 depicts a first embodiment of mouse 100. As shown, the mouse 100 comprises at least three movable portions, rear portion 10, front side portion 20 and front side portion 30. While shown as three distinct portions, additional movable portions can be provided. For example, rear portion 10 can be bifurcated along line 15.

The mouse 100 includes right and left mouse buttons 50 and 40 respectively. Additionally, a third button, scroll wheel 60, or the like is included. The mouse 100 can have a ball, light sensor, laser, or the like to determine motion. Other mouse configurations include additional mouse buttons, fewer mouse buttons, additional scroll wheels, fewer scroll wheels, and the like.

In operation, various portions of the mouse 100 are moved by a drive mechanism to alleviate the risks of RSI. The rear portion of the mouse 10 moves away from the front portions 20, 30 to elongate the mouse. Additionally, the rear 10 can move substantially perpendicular to the plane on which the mouse rides. In another embodiment, the rear is bifurcated so that portions of the mouse can move, thereby changing the relative rotational position of the hand and wrist.

The front portions of the mouse 20 and 30 can move both substantially perpendicular to the plane upon which the mouse rests as well as moving away from one another there by spreading apart from one another. In one embodiment, buttons 40, 50, and 60 move to vary the position of the user's hand. Buttons 40, 50 are adapted to move at least one of along the plane of the surface of the mouse body or raise and lower with respect to the surface of the mouse body.

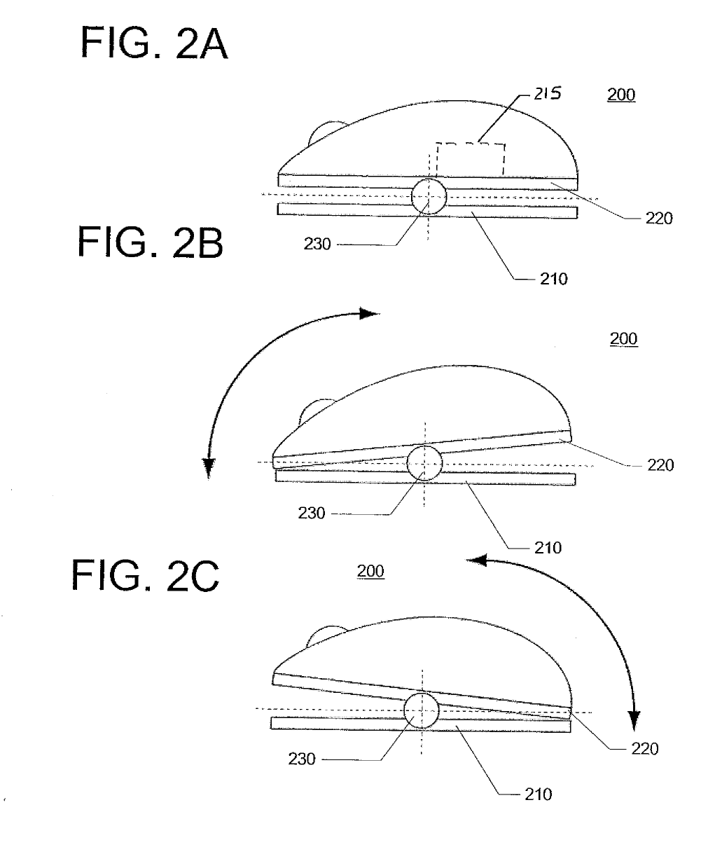

FIGS. 2a-2c depict a second embodiment of the ergonomic mouse 200. In this embodiment, a body 220 is coupled to a base 210 through a mount 230. The mount 230 can be a universal joint, pivot, hinge, axle, cam, track, track system, or the like. As shown in side view FIG. 2b, the mouse housing 220 pivots about coupling joint 230 so that the front and back of the housing 210 can substantially come in contact with base 210. It should be noted that in other embodiments, more or less motion is available. Further, housing 220 includes right and left mouse buttons as well as a scroll wheel or the like. Further, mouse 200 can track motion using a track ball, light sensor, LED, or the like. Other mouse configurations include additional or fewer mouse buttons, additional or fewer scroll wheels, and the like. The pivoting action shown in FIGS. 2A-2C is accomplished using a driving mechanism 215. The driving mechanism is coupled to a base of the mouse, the mouse body, and preferably, the buttons. The drive mechanism is preferably an electric motor and gear train.

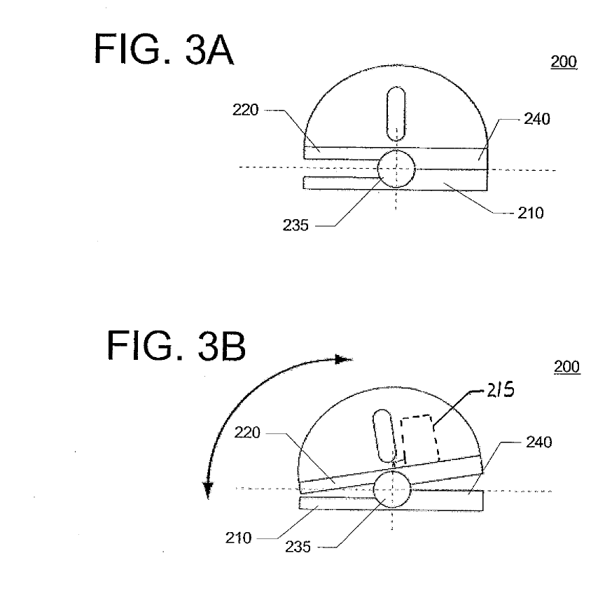

FIGS. 3a and 3b depict the mouse of FIG. 2 adapted for a right-handed user. The disclosed elements would be mirrored for a left-handed user. As shown, the housing 220 is coupled to base 210 through coupling joint 235. Coupling 235 may be the same as coupling joint 230. In another embodiment, there are separate coupling joints. Coupling joint 235 can be a hinge, an axle, a universal joint, a ball joint, cam, track, track system, or the like. The pivoting action shown in FIGS. 3A-3B is accomplished using a driving mechanism. The driving mechanism is coupled to a base of the mouse, the mouse body, and preferably, the buttons. The drive mechanism is preferably an electric motor and gear train 215.

As shown, a stop 240 prevents the mouse from pivoting beyond a certain point. Stop 240 is adapted to place the user's hand in an initial rest position. It should be noted that other mechanical stops can be used as well as other motion limiting techniques. From that initial point, the mouse pivots to reduce the risks of RSI. It should be noted that stop 240 is preferably adjustable. Additionally, the first embodiment can be combined with the embodiment disclosed in FIGS. 2 and 3.

It should be noted that the mouse 200 preferably is configured to pivot both side-to-side and front-to-back. Additionally, circular motion is possible. In another embodiment, the pointing device is a track ball. In this embodiment, the base is configured to move so that a user's hand changes orientation to use the trackball in a manner similar to mouse 200.

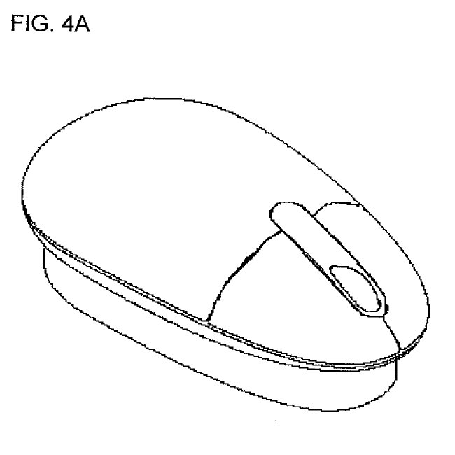

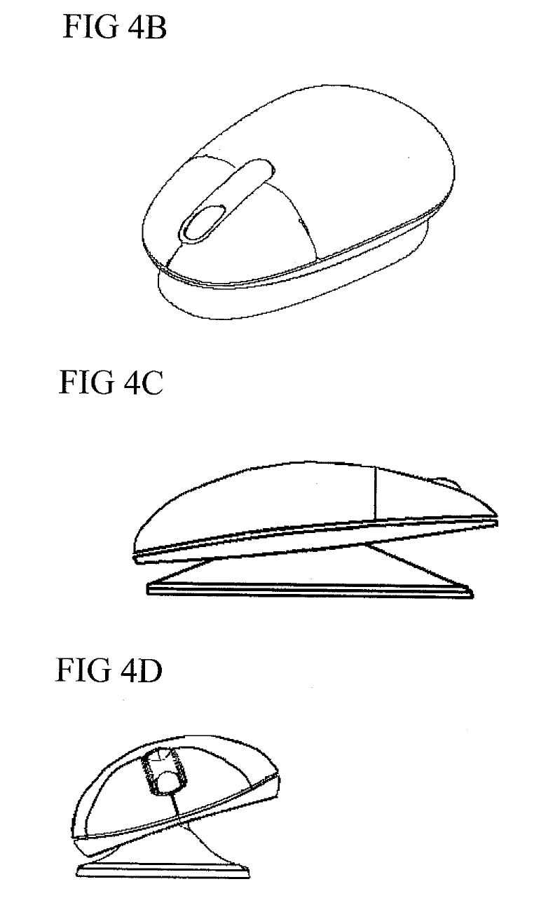

FIGS. 4a-4d depict another embodiment of the pointing device. As shown, the mouse has a single pivot point about which it changes position relative to the base. Like the other embodiments, one or more motors and one or more gear trains drive the mouse body. The gear train comprises one or more of a spur gear, a straight or spiral cut bevel gear, a worm gear, a planetary gear, a hypoid gear a helical gear, a herringbone gear, or the like. In one embodiment, electromagnets position the mouse body.

Control software preferably includes, but is not be limited to, programming aimed at relieving or preventing a specific disease such as carpal tunnel or other ailments due to repetitive motion. The gradual movements of the mouse body and the control buttons, eliminate repetitive motion from the same angle thereby improving blood flow, changing position of the median nerve, and resting overworked muscles. The control software preferably stores user information so that a specific user can have a designated motion profile.

The software programming will preferably monitor repetitive motion on specific buttons and adjust the mouse components accordingly. If a user is constantly focusing on one button motion, then the programming will preferably adjust that portion accordingly, moving it more frequently, or various other angles.

The software can be stored on the mouse itself, the computer or network to which it is attached, a third party computer or a server on the network, a dedicated hardware controller, or on an external source such as a key card or a USB memory card, solid state memory or other storage mechanisms.

In one embodiment, the customization of the software is manipulated by use of pre-programming, settings stored on the computer, server, or by user input. The configuration changes can be made automatically when the user logs on the computer or network. It can also be automatically configured with the help of biometrics or their personal key cards or identification cards. Once the user is identified, the software, wherever it is stored, can adjust the mouse for that specific user.

In one embodiment, the user can set the mouse or pointing device to a preferred position. The pointing device does not vary from that position or, alternatively, the user preset is the starting point for automatic motion.

Another embodiment could offer hand and wrist rest temperature changes in addition to the other mentioned adaptations to alleviate common hand and wrist and arm ailments. To that end, the mouse can be heated to warm a user's hands.

The mouse in FIGS. 1, 2, 3, and 4 are each motorized mice. The motor drives a gear train that is configured to drive the various portions of the mouse. For example, a first gear train causes the mouse to move side-to-side while a second gear train causes front-to-back movement. Alternatively, a single gear train causes all of the mouse motion. In one embodiment, the mouse is powered via the USB port. In an alternate embodiment, the mouse is battery powered, solar powered, or the like. The mouse can be wired or wireless. In another embodiment, the movement of the mouse on a planar surface powers the mouse. Additionally, the mouse can use any known method or apparatus to determine pointer motion such as a ball, light sensor, or the like

The mouse is preferably microprocessor controlled. The control can be performed via a PC or an on-board microprocessor. In one embodiment, a computer program running on the user's computer controls the motion. In another embodiment, the program is stored on firmware, onboard the mouse. In yet another embodiment, the program is stored in flash or other memory that can be updated. Control can also be transmitted from the keyboard or computer using wireless technology. In yet another embodiment, a server on a network such as a local LAN or the Internet controls the mouse.

The mouse's movement can be controlled in one of several manners. The mouse can change its position based on time, amount of use, distance moved temperature, heat, pulse rate, weight, or random motion. Regular rhythmic patterns may also be used to move various portions of the mouse. Movement may also be based on the program being used or expected mouse motions. For example, the mouse can be alerted that a program with heavy side to side movement is being used and so that movement may occur more often or with a different pattern.

In one embodiment, the motion is not continuous. In other words, the mouse will step between positions. The length of time the mouse remains in any given position will be based at least in part on the above factors.

In one embodiment, the mouse has a display window (not shown). In one embodiment, the display window is an LCD display. The display can include such items as the specific user, speed setting, motion type, and the like. In one embodiment, the display notifies the user of imminent motion.

In one embodiment of the invention, a user is prompted to use an exercise program based in part on the user's activity. The program will prompt the user to perform tasks to minimize the risk of RSI.

Acting as a robotic computer interface, the present mouse is programmable in three or more axes. Additionally, the present mouse is automatically controlled via programming. Further, the mouse is reprogrammable. In one embodiment, the robotic mouse includes adaptive programming that learns as it is used.

While this invention has been described by reference to a preferred embodiment, it should be understood that numerous changes could be made within the spirit and scope of the inventive concepts described. Accordingly, it is intended that the invention not be limited to the disclosed embodiment, but that it have the full scope permitted by the language of the following claims.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A pointing device comprising:
a base;
a motion tracking device coupled to the base;
a body pivotably coupled to the base; and
a drive coupled to the base and the body configured to pivot the body with respect to the base about at least one axis.

2. The pointing device according to claim 1, further comprising at least one button, wherein the drive causes the button to vary its position with respect to at least one of the body and the base.

3. The pointing device according to claim 1, wherein the drive causes the body to pivot about the at least two axes.

4. The pointing device according to claim 3, wherein the body further comprises at least two buttons at a first end of the body and a second end of the body adapted to a palm of a user.

5. The pointing device according to claim 4, wherein the drive extends a length of the housing between the first and the second ends.

6. The pointing device according to claim 4, wherein the drive varies a distance between the two buttons.

7. The pointing device according to claim 3, wherein the drive pivots the body when a predetermined condition occurs.

8. The pointing device according to claim 4, wherein each of the body portions is adapted to move independently.

9. The pointing device according to claim 4, wherein the body portions move in a synchronized manner.

10. The pointing device according to claim 7, wherein the predetermined conditions are customized based in part on a desired motion.

11. The pointing device according to claim 3, further comprising a controller, said controller adapted to monitor parameters including at least one of button presses, time, and motion, said controller activating the drive based on the parameters.

12. The pointing device according to claim 11, wherein the controller is integral to the pointing device.

13. The pointing device according to claim 11, wherein the controller is a portion of a device to which the pointing device is connected.

14. The pointing device according to claim 13, wherein the device to which the pointing device is connected is a computer.

15. The pointing device according to claim 3, wherein the pointing device is a mouse.

16. The pointing device according to claim 3, wherein the pointing device is a trackball.

17. The pointing device according to claim 3, further comprising an indicator portion on the housing, the indicator adapted to signal movement of the pointing device body relative to the base.

18. The pointing device according to claim 3, further comprising a stop to limit the side-to-side pivoting of the body with respect to the base.

19. The pointing device according to claim 3, wherein the drive is a motor.

20. A method of operating a pointing device, the pointing device comprising a base, a body pivotably coupled to the base, and a drive mechanism adapted to pivot the body about at least one axis, the method comprising:
connecting the pointing device to a computer;
monitor parameters including at least one of button presses, time, and position;
activating the drive mechanism based on the parameters, the drive mechanism varying a position of at least the body with respect to the base.
